(19) United States
(12) Patent Application Publication
(10) Pub. No.: US 2023/0015288 A1
(43) Pub. Date: Jan. 19, 2023

(54) TERMINAL-EQUIPPED WIRE

(71) Applicant: SUMITOMO WIRING SYSTEMS, LTD., Mie (JP)

(72) Inventors: Takuya OSHITA, Mie (JP); Naomichi KAWASHIMA, Mie (JP)

(21) Appl. No.: 17/783,270

(22) PCT Filed: Nov. 24, 2020
(86) PCT No.: PCT/JP2020/043621

§ 371 Date: Jun. 8, 2022

(30) Foreign Application Priority Data
Dec. 13, 2019 (JP) 2019-225157

(51) Int. Cl. H01R 4/18

(52) U.S. Cl. CPC H01R 4/185

(57) ABSTRACT

A terminal-equipped wire 1 is provided with a terminal 10 and a coated wire W pulled out rearward from the terminal 10. The terminal 10 includes a wire barrel portion 20 to be crimped to a core wire W1 in an end of the coated wire W. The wire barrel portion 20 includes a crimping bottom surface 22 and a pair of wire barrel pieces 21 extending from both side edges of the crimping bottom surface 22. A front end part of the core wire W1 is covered by front end parts of the pair of wire barrel pieces 21 of the wire barrel portion 20. A confirmation hole 40 enabling confirmation of the front end part of the core wire W1 is provided in the crimping bottom surface 22 of the wire barrel portion 20.

### TECHNICAL FIELD

The present disclosure relates to a terminal-equipped wire.

### BACKGROUND

A structure for connecting a terminal to an end of a wire is configured such that a wire barrel is crimped to a core wire of the wire and an insulation barrel is crimped to an insulation coating. Here, the problem is that, in crimping the wire barrel to the core wire, a front end part of the core wire projects from a crimping portion and is tipped up. For example, if such a terminal is used in a waterproof connector, a sealing member may be broken by the tipped-up front end part of the core wire and waterproofness may be reduced when the terminal is passed through a through hole of the sealing member.

A terminal crimping structure for solving such a problem is known from Japanese Patent Laid-open Publication No. 2008-181813 (Patent Document 1 below). A wire barrel of this terminal crimping structure includes an effective crimping portion to be crimped to a core wire of a wire and an extending portion for covering a front end part of the core wire of the wire. In this way, the front end part of the core wire is not exposed and the front end part of the core wire can be prevented from being tipped up. Further, the extending portion is provided with a confirmation hole and the position of the front end part of the core wire can be confirmed with the wire barrel crimped to the core wire of the wire.

### PRIOR ART DOCUMENT

### Patent Document

Patent Document 1: JP 2008-181813 A

### SUMMARY OF THE INVENTION

### Problems to be Solved

In the above terminal crimping structure, the extending portion is provided to cover the front end part of the core wire of the wire and the entire length of the wire barrel needs to be extended. Thus, this structure is not suitable for an application requiring the miniaturization of a terminal and is disadvantageous also in terms of cost reduction.

A technique disclosed in this specification was completed on the basis of the above situation and aims to provide a terminal-equipped wire capable of preventing a front end of a core wire from being tipped up beyond a crimping portion and enabling the confirmation of the position of the front end of the core wire through a confirmation hole without changing the entire length of a wire barrel.

### Means to Solve the Problem

The present disclosure is directed to a terminal-equipped wire with a terminal and a coated wire pulled out rearward from the terminal, wherein the terminal includes a wire barrel portion to be crimped to a core wire in an end of the coated wire, the wire barrel portion includes a crimping bottom surface and a pair of wire barrel pieces extending from both side edges of the crimping bottom surface, a front end part of the core wire is covered by front end parts of the pair of wire barrel pieces of the wire barrel portion, and a confirmation hole enabling confirmation of the front end part of the core wire is provided in the crimping bottom surface of the wire barrel portion.

Effect of the Invention

According to the present disclosure, it is possible to prevent a front end part of a core wire from being tipped up beyond a crimping portion and enable the confirmation of the position of the front end of the core wire through a confirmation hole.

### BRIEF DESCRIPTION OF THE DRAWINGS

FIG. 1 is a perspective view of a terminal-equipped wire according to a first embodiment.

FIG. 2 is a bottom view of the terminal-equipped wire according to the first embodiment.

FIG. 3 is a section along A-A of FIG. 2.

FIG. 4 is a development of a terminal according to the first embodiment.

FIG. 5 is a perspective view of a terminal-equipped wire according to a second embodiment.

FIG. 6 is a bottom view of the terminal-equipped wire according to the second embodiment.

FIG. 7 is a section along B-B of FIG. 6.

FIG. 8 is a development of a terminal according to the second embodiment.

### DETAILED DESCRIPTION TO EXECUTE THE INVENTION

### Description of Embodiments of Present Disclosure

First, embodiments of the present disclosure are listed and described.

(1) The terminal-equipped wire of the present disclosure is provided with a terminal and a coated wire pulled out rearward from the terminal, wherein the terminal includes a wire barrel portion to be crimped to a core wire in an end of the coated wire, the wire barrel portion includes a crimping bottom surface and a pair of wire barrel pieces extending from both side edges of the crimping bottom surface, a front end part of the core wire is covered by front end parts of the pair of wire barrel pieces of the wire barrel portion, and a confirmation hole enabling confirmation of the front end part of the core wire is provided in the crimping bottom surface of the wire barrel portion.

Since the front end part of the core wire is covered by the wire barrel pieces, the core wire is not exposed to the outside of the wire barrel portion and the front end part of the core wire can be prevented from being tipped up. Further, the position of the front end part of the core wire can be confirmed through the confirmation hole provided in the crimping bottom surface of the wire barrel portion.

(2) Preferably, the shape of the confirmation hole is tapered to front.

By providing the confirmation hole, there is a concern that strength around the confirmation hole of the terminal is reduced. However, by forming the confirmation hole into a tapered shape, a reduction in strength around the confirmation hole can be suppressed.

### Details of Embodiments of Present Disclosure

Hereinafter, embodiments of the present disclosure are described. Note that the present invention is not limited to these illustrations and is intended to be represented by claims and include all changes in the scope of claims and in the meaning and scope of equivalents.

### First Embodiment

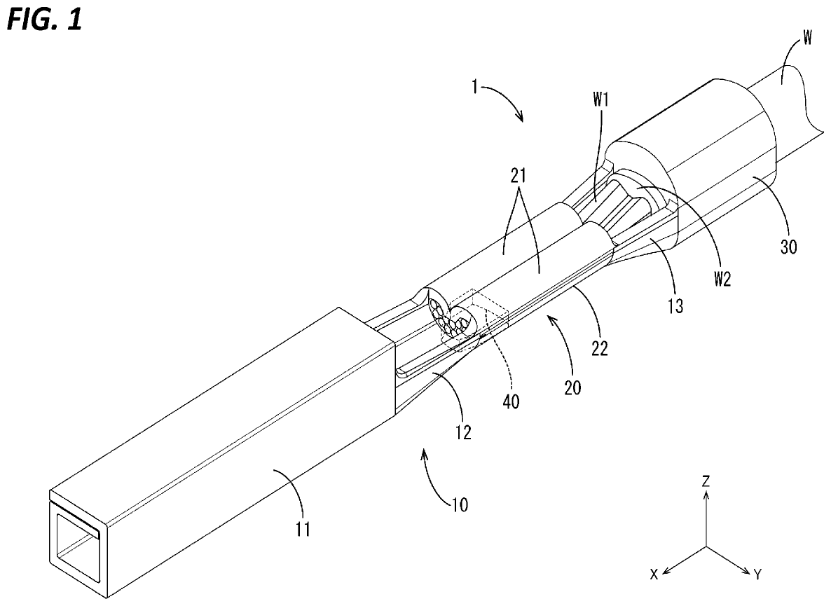

A first embodiment of the present disclosure is described with reference to FIGS. 1 to 4. In the following description, an X direction, a Y direction and a Z direction in FIGS. 1 to 3 are referred to as a forward direction, a rightward direction and an upward direction. Note that a “front end” means a part at a foremost position in a front-rear direction and a “front end part” means a part near the front end including the front end and a region somewhat behind the front end.

[Terminal-Equipped Wire, Coated Wire, Terminal]

As shown in FIG. 1, the terminal-equipped wire 1 includes a terminal 10 and a coated wire W pulled out rearward from the terminal 10. The coated wire W is configured such that a core wire W1 is covered with an insulation coating W2. The terminal 10 is shaped to be long in the front-rear direction and includes a connecting tube portion 11, a wire barrel portion 20 and an insulation barrel portion 30. The wire barrel portion 20 is behind the connecting tube portion 11 and connected to the connecting tube portion 11 via a first coupling portion 12. The insulation barrel portion 30 is behind the wire barrel portion 20 and connected to the wire barrel portion 20 via a second coupling portion 13.

[Connecting Tube Portion]

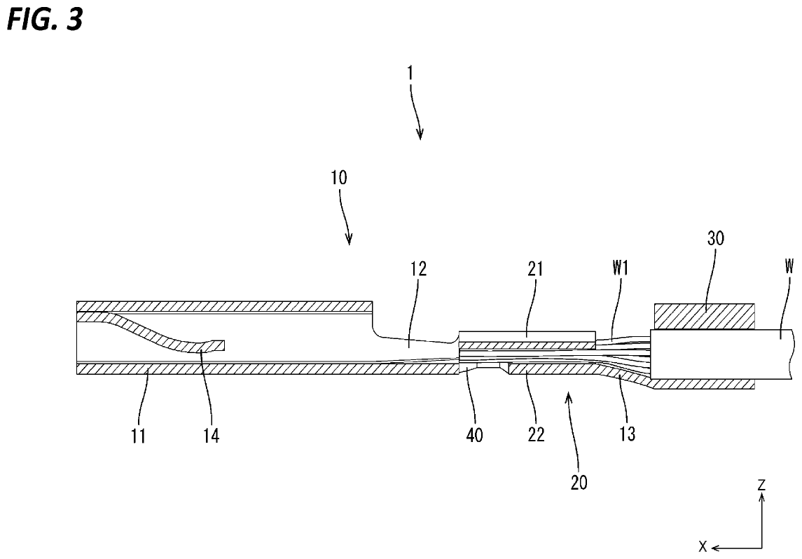

The connecting tube portion 11 is provided on a front end side of the terminal 10 and in the form of a rectangular tube capable of receiving an unillustrated mating male terminal. A contact piece 14 is provided inside the connecting tube portion 11 as shown in FIG. 3. With the male terminal accommodated in the connecting tube portion 11, the contact piece 14 is resiliently in contact with the male terminal and the terminal-equipped wire 1 is electrically connected to the male terminal.

[Wire Barrel Portion]

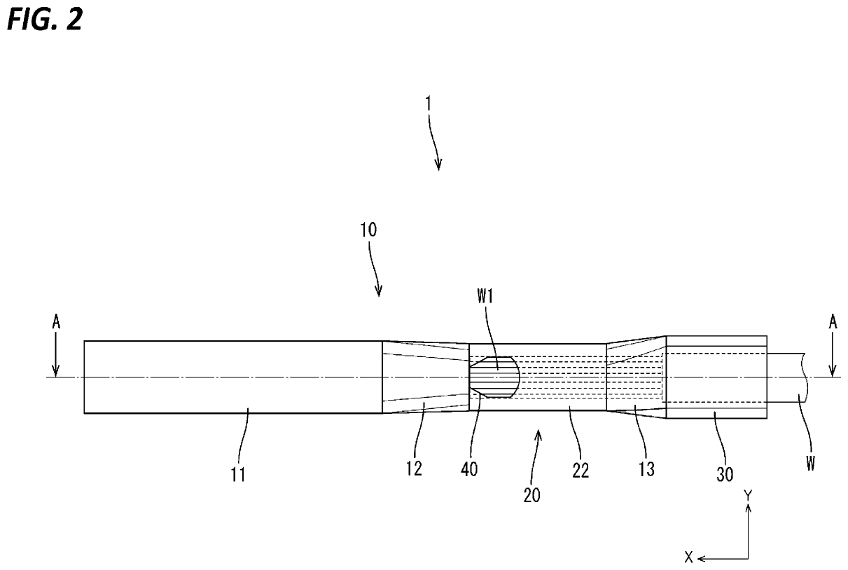

As shown in FIG. 1, the wire barrel portion 20 includes a crimping bottom surface 22 and a pair of wire barrel pieces 21 extending from both side edges of the crimping bottom surface 22. Surfaces of the crimping bottom surface 22 and the wire barrel pieces 21 to be held in contact with the core wire W1 are serrated (not shown). The wire barrel pieces 21 are crimped to the core wire W1 to cover a front end part of the core wire W1 placed on the crimping bottom surface 22 as shown in FIGS. 1 and 2.

[Confirmation Hole]

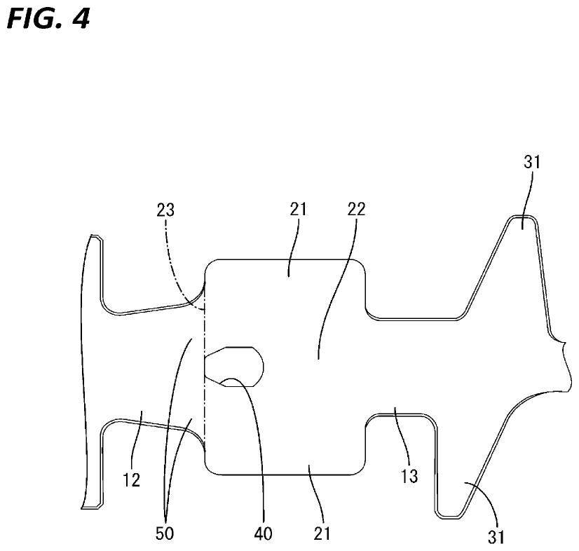

As shown in FIGS. 1 to 4, a confirmation hole 40 enabling the confirmation of the front end of the core wire W1 crimped by the wire barrel portion 20 from outside is formed in a front center of the crimping bottom surface 22. Here, visual confirmation by the naked eye, the analysis of an image photographed by a camera and the like are, for example, illustrated as examples of confirmation. The front end of the confirmation hole 40 is disposed to coincide with front ends 23 of the wire barrel pieces 21 as shown by a broken line of FIG. 4.

When the wire barrel pieces 21 are crimped to the core wire W1, the front end of the crimped core wire W1 does not protrude forward from the wire barrel portion 20 and can be confirmed through the confirmation hole 40 if the front end of the core wire W1 is disposed at least rearward of the front ends 23 of the wire barrel pieces 21 and forward of the rear end of the confirmation hole 40.

Further, since the wire barrel portion 20 is crimped by being pressed in the vertical direction by a crimping jig, the front end part of the core wire W1 does not pop out downward from the confirmation hole 40 in the crimped state even if the front end of the core wire W1 is disposed inside the confirmation hole 40.

Note that, to improve the crimp strength of the core wire W1 in the wire barrel portion 20, the front end of the core wire W1 and the front end of the confirmation hole 40 are better to be near the front ends 23 of the wire barrel pieces 21 and the confirmation hole 40 is better to be small

As shown in FIG. 4, parts having a short distance between the hole edge of the confirmation hole 40 and the side edge of the first coupling portion 12 are easily broken by an external force and serve as fragile portions 50. Since the confirmation hole 40 has a home base shape tapered to the front, minimum dimensions of the fragile portions 50 can be increased and a reduction in strength due to the thinning of the fragile portions 50 can be suppressed.

[Insulation Barrel Portion]

The insulation barrel portion 30 includes a pair of insulation barrel pieces 31 as shown in FIGS. 1 to 3. The insulation barrel pieces 31 are crimped to the insulation coating W2 of the coated wire W to wind around the insulation coating W2.

[Functions and Effects of Embodiment]

According to this embodiment, the following functions and effects are achieved. The terminal-equipped wire 1 according to this embodiment includes the terminal 10 and the coated wire W pulled out rearward from the terminal 10, the terminal 10 includes the wire barrel portion 20 to be crimped to the core wire W1 in an end of the coated wire W, the wire barrel portion 20 includes the crimping bottom surface 22 and the pair of wire barrel pieces 21 extending from the both side edges of the crimping bottom surface 22, the front end part of the core wire W1 is covered by front end parts of the pair of wire barrel pieces 21 of the wire barrel portion 20, and the confirmation hole 40 enabling the confirmation of the front end part of the core wire W1 is provided in the crimping bottom surface 22 of the wire barrel portion 20.

Since being covered by the wire barrel pieces 21, the front end part of the core wire W1 is not exposed forward of the wire barrel portion 20 and can be prevented from being tipped up. Further, the position of the front end part of the core wire W1 can be confirmed through the confirmation hole 40 provided in the crimping bottom surface 22 of the wire barrel portion 20.

Further, the shape of the confirmation hole 40 is preferably tapered to the front.

By tapering the confirmation hole 40, a reduction in strength due to the thinning of the fragile portions 50 can be suppressed.

### Second Embodiment

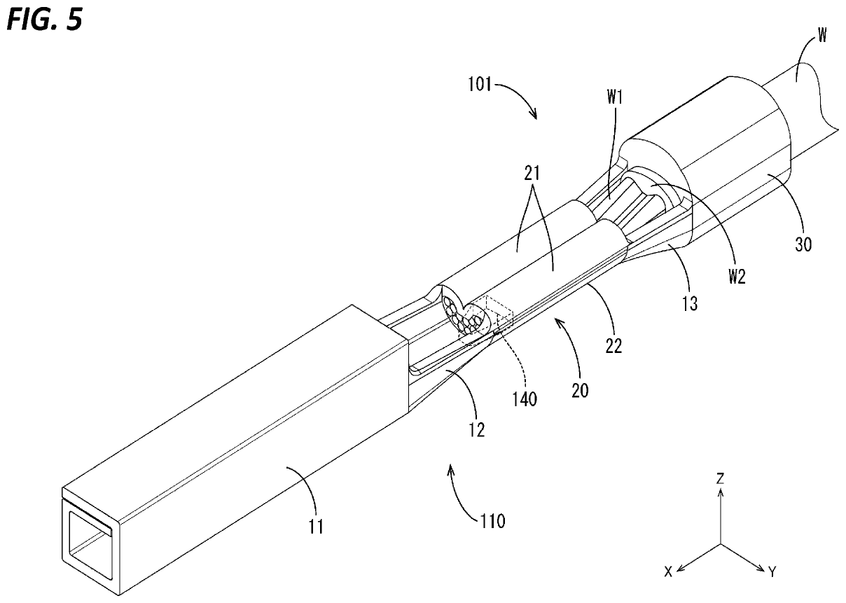

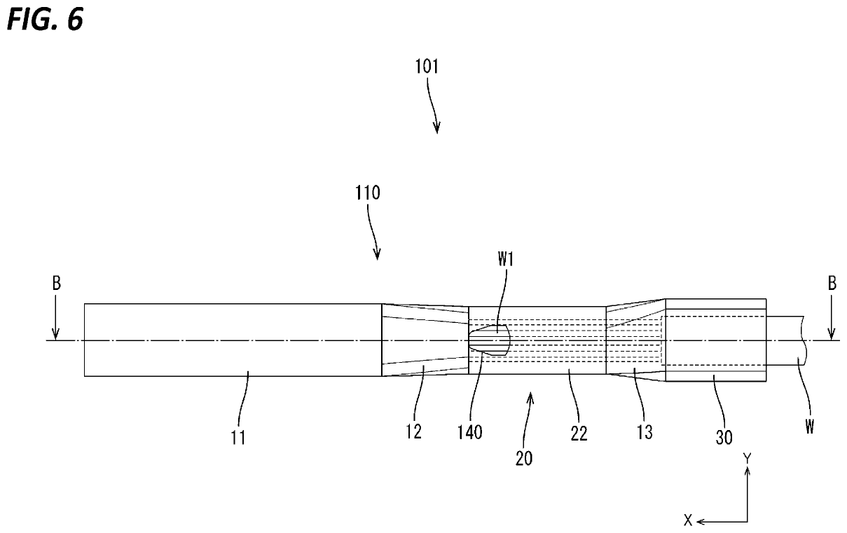

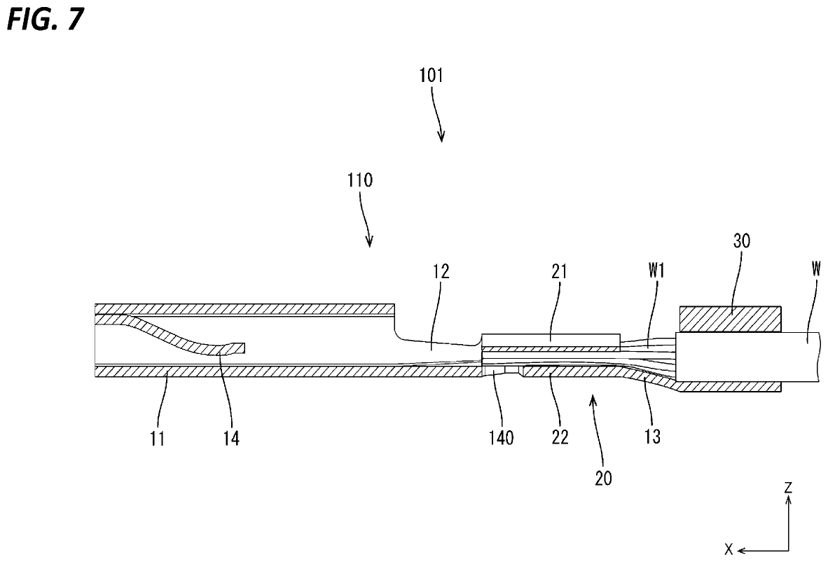

A second embodiment of the present disclosure is described with reference to FIGS. 5 to 8. In the following description, an X direction, a Y direction and a Z direction in FIGS. 5 to 7 are referred to as a forward direction, a rightward direction and an upward direction. Note that the same components as in the first embodiment are not described and are denoted by the same reference signs as in the first embodiment.

[Terminal-Equipped Wire, Coated Wire, Terminal]

As shown in FIG. 5, a terminal-equipped wire 101 according to this embodiment includes a terminal 110 and a coated wire W pulled out rearward from the terminal 110.

[Confirmation Hole]

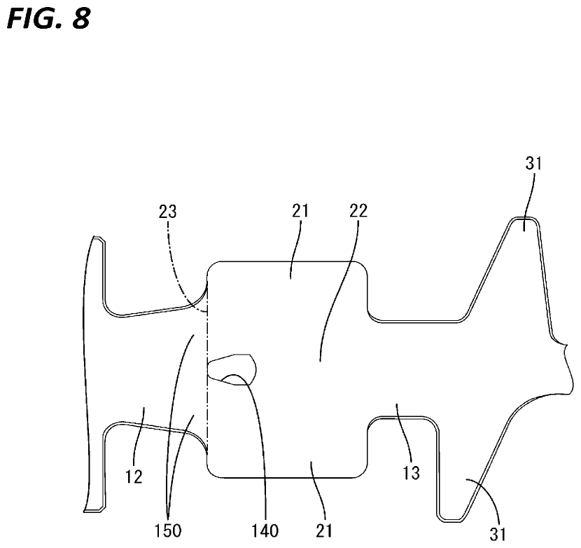

As shown in FIGS. 5 to 8, a confirmation hole 140 enabling the confirmation of the front end of a core wire W1 crimped by a wire barrel portion 20 from outside is formed in a front center of a crimping bottom surface 22. The front end of the confirmation hole 140 is disposed to coincide with front ends 23 of wire barrel pieces 21 as shown by a broken line of FIG. 8. The front end of the confirmation hole 140 may be disposed rearward of the front ends 23 of the wire barrel pieces 21.

As shown in FIG. 8, parts having a short distance between the hole edge of the confirmation hole 140 and the side edge of a first coupling portion 12 are easily broken by an external force and serve as fragile portions 150. Since the confirmation hole 140 has an egg shape tapered to the front, minimum dimensions of the fragile portions 150 can be increased and a reduction in strength due to the thinning of the fragile portions 150 can be suppressed. Further, since the confirmation hole 140 is smaller than the confirmation hole 40 of the first embodiment, the fragile portions 150 have better strength than the fragile portions 50 of the first embodiment.

### Other Embodiments

(1) The size and shape of the confirmation hole may be changed according to the size of the terminal and required crimp strength. A triangular shape, a pentagonal shape, an elliptical shape or the like may be, for example, used as a tapered shape.

(2) Although the front ends 23 of the wire barrel pieces 21, the front end of the confirmation hole 40, 140 and the front end of the core wire W1 coincide in the figures of the above embodiments, there is no limitation to this. It is sufficient that the front end of the core wire is disposed rearward of the front ends of the wire barrel pieces and the front end of the core wire can be confirmed through the confirmation hole provided in the crimping bottom surface.

(3) Although a female terminal including the connecting tube portion 11 is used as the terminal 10, 110 in the above embodiments, there is no limitation to this. A male terminal having a tab shape may be used as a terminal.

(4) Although the core wire W1 is a stranded wire composed of a plurality of metal strands in the above embodiment, the core wire W1 may be a single core wire.

### LIST OF REFERENCE NUMERALS

1, 101: terminal-equipped wire

10, 110: terminal

11: connecting tube portion

12: first coupling portion

13: second coupling portion

14: contact piece

20: wire barrel portion

21: wire barrel piece

22: crimping bottom surface

23: front end of wire barrel piece

30: insulation barrel portion

31: insulation barrel piece

40, 140: confirmation hole

50, 150: fragile portion

W: coated wire

W1: core wire

W2 insulation coating

What is claimed is:

1. A terminal-equipped wire, comprising:
a terminal; and
a coated wire pulled out rearward from the terminal,
wherein:
the terminal includes a wire barrel portion to be crimped to a core wire in an end of the coated wire,
the wire barrel portion includes a crimping bottom surface and a pair of wire barrel pieces extending from both side edges of the crimping bottom surface,
a front end part of the core wire is covered by front end parts of the pair of wire barrel pieces of the wire barrel portion, and
a confirmation hole enabling confirmation of the front end part of the core wire is provided in the crimping bottom surface of the wire barrel portion.

2. The terminal-equipped wire of claim 1, wherein the shape of the confirmation hole is tapered to front.
